(19) United States
(12) Patent Application Publication
(10) Pub. No.: US 2013/0332195 A1
(43) Pub. Date: Dec. 12, 2013

(54) SYSTEM AND METHODS FOR EPIDEMIOLOGICAL DATA COLLECTION, MANAGEMENT AND DISPLAY

(71) Applicants: SONY NETWORK ENTERTAINMENT INTERNATIONAL LLC, Los Angeles, CA (US); SONY CORPORATION, Tokyo (JP)

(72) Inventor: Albhy Galuten, Santa Monica, CA (US)

(73) Assignees: SONY NETWORK ENTERTAINMENT INTERNATIONAL LLC, Los Angeles, CA (US); SONY CORPORATION, Tokyo (JP)

(21) Appl. No.: 13/848,718

(22) Filed: Mar. 21, 2013

Related U.S. Application Data
(60) Provisional application No. 61/689,607, filed on Jun. 8, 2012.

(51) Int. Cl. G06F 19/00; G06Q 50/24

(52) U.S. Cl. CPC G06F 19/3493; G06Q 50/24
USPC 705/3

(57) ABSTRACT

A method and system for collecting, protecting, pre-processing, storing, sorting, filtering and accessing with granular control of permissions, medical data associated with one or more individual patients, practitioners, suppliers or research facilities taking into account the interrelationships between and among all the data and the participants and then displaying this data in dynamically generated low-latency fashion to any of the above participants and enabling the use of real time epidemiological data to make medical and lifestyle decisions.

### CROSS-REFERENCE TO RELATED APPLICATIONS

This application is a nonprovisional of U.S. provisional patent application Ser. No. 61/689,607 filed on Jun. 8, 2012, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to medical data management, and more particularly to epidemiological data collection, management and display.

2. Description of Related Art

Data Storage has grown in size and scale and has decreased in cost such that it is now essentially limitless. In parallel, the amount of medical data we collect is growing exponentially. Human genomes will soon be part of a patient's medical record. But beyond this, real-time data collection of things like blood chemistry, heart rate, blood pressure, brain wave activity, respiration and dozens of other factors is beginning in earnest. Additionally, lifestyle data (which also affects health) is now being collected. Health records have historically not been accessible except to those with access to the paper records. This is changing, and soon virtually all records (and the additional factors mentioned above) will be stored in perpetuity in the cloud and accessed dynamically. We are entering a time when a typical patient can have many thousands or, with real-time monitoring of bio-factors, millions or billions of different data points. Additionally, there is metadata associated with all of these records (e.g. time and place), and these data all interact. The heart rate affects the blood pressure which is also affected by the brain wave activity and the blood chemistry. With proper access to such data, medical care is capable of being less general and more customized to the individual patient.

A patient, doctor, hospital, pharmaceutical company, university or health insurer will be faced with sorting through billions or trillions of data points. Today, searches are only navigable using the coarsest means and do not make inferences about how the data interact. As the global medical data become larger and more accessible there is a need to view this data in targeted and useful ways while still restricting access to only those appropriate entities—those entities with both a need to know and the permission of the correct people (e.g. the doctors, the patients, etc.).

The User Interface (UI) currently associated with large data sets is poorly defined. It is cumbersome and inefficient. There is a need for a method and mechanism that allows users (doctor, patient, research institute, pharmaceutical company) to have access (as appropriate) to all the data elements across a number of axes and with the appropriate filters (to limit the results) and context (metadata and temporal information) to allow a user to quickly and easily find the aggregated and pre-digested data they are seeking.

### BRIEF SUMMARY OF THE INVENTION

The present invention relates to collecting, searching, sorting, filtering and displaying medical data. In particular the invention describes ways of managing extremely large amounts of data from a multitude of entities and analyzing that data in relationship to other entities and other data. Individual patient data including bio-factors (blood chemistry, brain wave activity, heart and respiratory activity), environmental factors (diet, sleep, exercise, air quality, etc.) genetic factors, psychological proclivities (Meyers Briggs, brain chemistry, etc.), social factors (degrees of influence, behavior) and medical history (medications, diseases, treatments, etc.) is mapped against data from other patients, using that data to inform decisions about treatment and lifestyle choices. The field of the Invention also includes novel ways of parsing and displaying that data in ways that can be easily utilized by humans and by machines. Additionally the invention addresses problems associated with the combination of scalability and security of data and granular control of access to it.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a high level schematic diagram of the medical data management system of the present invention.

FIG. 2 is a flow diagram of an exemplary preprocessing routine in accordance with the present invention.

FIG. 3 is a flow diagram of an exemplary query preparation in further detail.

FIG. 4 shows a detailed flow diagram of the data query and return process of the present invention.

FIG. 5 shows a flow diagram of a detailed view of the display step of FIG. 4.

FIG. 6 is a schematic diagram illustrating mapping of permissions and access in accordance with the present invention.

FIG. 7 is a schematic diagram illustrating the elements used in aggregating data in accordance with the present invention.

FIG. 8 is a schematic diagram illustrating the processing of the query and the creation of aggregated data and their references (super-node aliases).

FIG. 9 is a view of certified processes and filters being used on data from multiple repositories;

FIG. 10 is a view of processes that may occur when navigating the links from node to node;

FIG. 11 is a further view of processes that may occur when navigating the links from node to node showing the use of an expert system;

FIG. 12 is a view of the basic steps employed preparing the data for display;

FIG. 13 is a view of a display of the results of an example query.

### DETAILED DESCRIPTION OF THE INVENTION

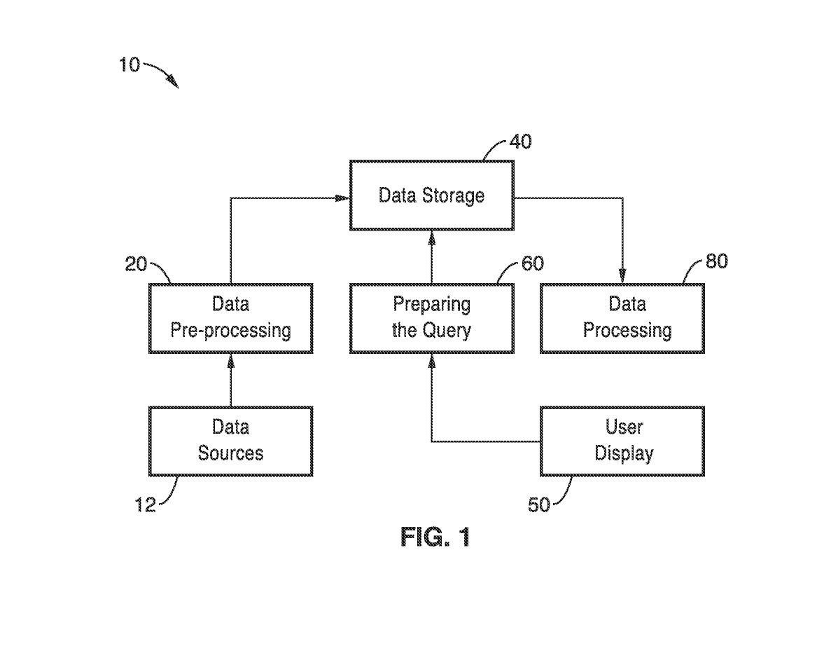

The present invention is directed to a system and method for epidemiological data collection, management and display, as embodied in FIG. 1 through FIG. 13 below. The system and method have several primary components that work in concert to improve epidemiology within the medical field. The system and method of the present invention are first detailed from a high-level system view, with respective components subsequently discussed individually.

System Overview and the Relationship of the Architectural Elements

FIG. 1 is a high level schematic diagram of the medical data management system 10 of the present invention showing the relationship of the architectural elements to one another. In one embodiment, system 10 may comprise an epidemiological data center (EDC) configured for data collection, management and display of acquired medical data. As shown in FIG. 1, the medical data 12 may be received via various sources e.g. computers, equipment, smartphones, etc. Data 12 may be collected by practitioners, or provided directly from sensors worn or used by the patient or collected from external data on web sites or other databases.

The collected data 12 are then prepared for storage at pre-processing module 20. After pre-processing, the data are sent to a storage repository 40 that will make the data available as required later. Following that, a user dashboard or display 50 is used to query the data in storage 40. A query module 60 prepares the data, such that the message is protected and the data requested properly matches to the result wanted. The data is then processed for return to the user with processing module 80, using numerous functions and filters, some or all of which may be secure. The results of that data aggregation, processing and filtering are then returned to the user dashboard 50, where they are displayed in comparative fashion using the principles of lenses and targets, as will be explained in further detail below.

Data 12 may be collected from a plethora of different sources in a number of different ways. Any source is possible, but some envisioned sources are: medical records (from doctors, hospitals, pharmacies, other practitioners), demographic data, weight (and weight change history), height (over time), age, sex marital/relationship history, psychological history (e.g. Meyers Briggs test, therapy history, etc.), address history including environmental factors like hours of sunlight, humidity, altitude, etc., genetic makeup including genetic triggering actors, drug history (pharmaceutical and recreational including alcohol & caffeine), sleep history (possibly monitored in real time), brain wave history (possibly monitored in real time), heart activity history (possibly monitored in real time), blood chemistry history (possibly monitored in real time), exercise history (possibly monitored in real or near real time), dietary history (possibly monitored in real or near real time), etc.

Some of the different methods of collecting the data 12 may comprise: health records as taken by doctors in office, clinic, hospital, etc., pharmaceutical records, results of tests or lab work taken, information provided by the patient or others by any means including email, phone, on social networks or as told to others, from biometric sensors as may be worn by the patient (including data from portable sensors transmitted via mobile networks or over the internet), external environmental data from public and private records for things like weather, air quality and important psychological events (e.g. from a super-bowl win to the 9/11 attacks), relationship to others in a social graph (like Facebook) and how those factors above which have influence on parties once, twice or thrice removed can have influence on the subject.

In one embodiment, patient data is stored in a database 40 comprising an Epidemiological Data Center (EDC). This data center could be a single computer, or, more likely, a distributed network of many computers (servers).

These data are stored in such a manner that all keys and schema are dynamic. Fields of data always refer back to an authoritative source which is the single root of that data. Queries for that data can be directed to the authoritative source but more often will be directed to the nearest cache of the data. All caches have time stamps and the veracity of the data is inversely proportional to the age of the time in the time stamp. This time stamp can be used to calculate a veracity index. The veracity index is also based on whether the data on that machine has been found to have errors. The veracity index can be used as a factor when making a query. For example, data to be used in making a life and death decision might want a high degree of veracity as a reasonable trade off in exchange for a bit of latency. To the contrary, checking the results of lifestyle changes against data in real time might be more sensitive to latency while the guarantee of accuracy is not necessary.

Pre-Processing Data in Preparation for Upload

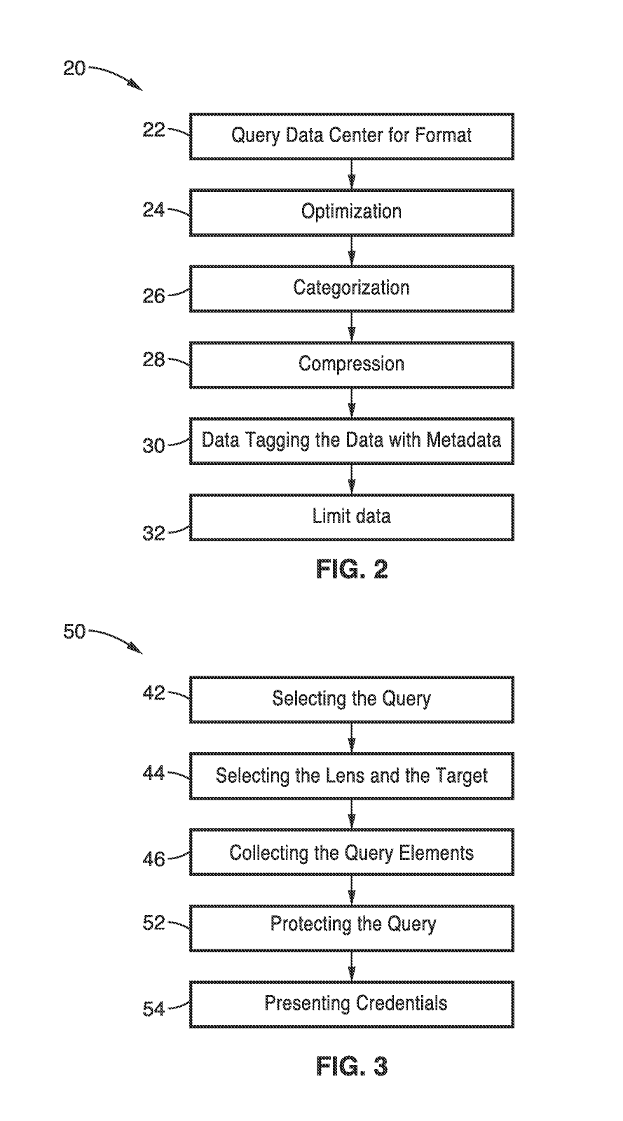

Data which has been or is being collected is prepared for upload to an EDC 10 storage repository 40 may be optimized (e.g. preprocessing 20) before upload. FIG. 2 illustrates a flow diagram of an exemplary preprocessing routine 20 in accordance with the present invention. The client may first query the EDC at step 22 regarding the expected format based on the type of data and additional storage algorithms accepted.

Before optimization, unneeded data may be discarded based on resolution and detail to be stored. The data 12 may then be optimized at step 24 and categorized at step 26 in preparation for upload. With respect to optimization step 24, cyclical data that can be represented graphically (like heart rate or brain wave activity) can be converted to formulas which can be reconstructed as needed. In particular, visualization algorithms may be run on the data, such as 3D models of brain wave activity from multiple sensors, or creating formulas that represent the graphs of cyclical data like heart rate, EMG (electromyography), blood sugar (perhaps related to food intake)—note, because of the non-time-critical nature of some of the data, the sensors can do their algorithmic optimizations over a period of hours, days or weeks to mitigate the bandwidth, storage and processing constraints listed above.

With respect to categorization step 26, it may be appropriate to place data in a multi-dimensional matrix for compatibility with storage matrices commonly used (e.g. using time as the third dimension or multiple points in brainwave capture to visualize the data without explicit data replication).

Compression algorithms may be used at step 28 to compress the data. Exemplary compression techniques comprise: Lempel-Ziv, Huffman (or arithmetic) encoding, probabilistic models, such as prediction by partial matching and grammar based codes such as Sequitur and Re-Pair. For some data, lossless compression may be necessary. For other data, lossy compression may be sufficient.

After compression, the data is then tagged with metadata at step 30 to describe the type of data it is and any transforms used, including compression algorithm and the type of visualization structure employed. Accordingly, tags associated with the data can help parsers order and evaluate the data.

The data may also be limited or further parsed prior to transmission at step 32. Some of the data, particularly in cases where the data is not expected to be useful in its original form, may not be needed later. Step 32 may be achieved by using lossy compression algorithms, or by discarding portions of the ranges or domains or degrees of granularity determined not to be relevant.

Individual user data which is gathered locally can be protected locally using existing technologies. However preparation of that data for storage remotely (e.g. database 40), or controlling access to that data from third parties (e.g. in the case where the data repository pings the client to capture data as opposed to the case where the client targets the data at a specific repository or set of repositories) is not so straightforward. The need to preprocess the data (as above) that is targeted at a particularly repository can be broken into a few additional steps, as detailed with respect to query preparation below.

Query Preparation

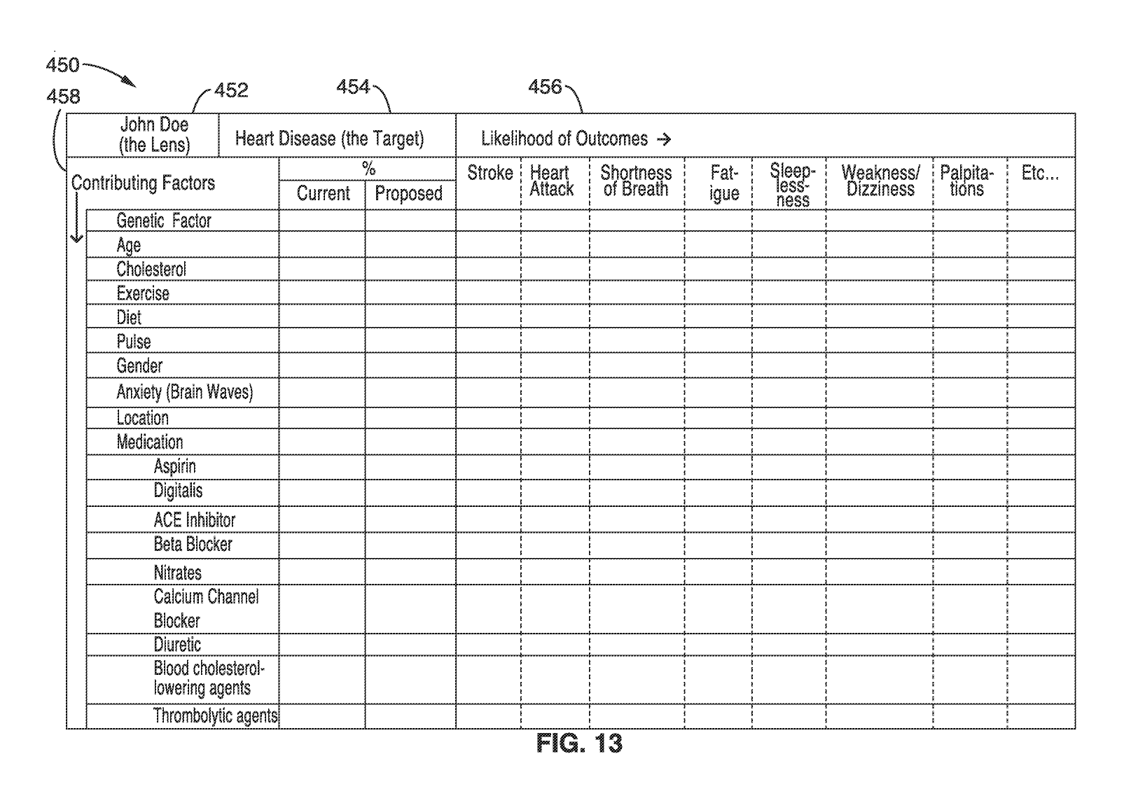

In order to properly query an EDC, a query will need to be prepared. FIG. 3 illustrates an exemplary query preparation 50 in further detail. First, typically using an Epidemiological Data Dashboard (as, for example, dashboard 450 shown in FIG. 13), the end user (e.g. patient, practitioner, university, pharmaceutical company, etc.) must determine what question they want to ask at step 42. The end user chooses the lens and the target at step 44, and the elements of the query are collected at step 46.

During the process of selecting the lens 452 (FIG. 13), the perspective is established. That is, what is the focus of the query meant to refer to? If it is a patient, the query elements will include all the factors about the patient which are relevant to the query. If it is a hospital, the query elements will include all the factors about the hospital that are relevant to the query. Similar logic is used with regard to the Lens of any query (a disease, a study, a drug, a research facility, a genome, a genetic factor, etc.). These query elements are all placed in the “Lens Bucket,” e.g. the elements through we will view the results of the query.

The collection of query elements step 46 further includes the selection of a target 454 (e.g. a disease, a patient, a study, etc.). Those elements 458 of the target 454 that may be relevant to the lens 452 are also collected. For example, one may want to know about cholesterol or shortness of breath if the target is heart disease. All of these elements are collected and tagged.

Before these elements are sent to the EDC for processing, they may preferentially be protected at step 52. This might typically be done with the private key of some combination of the querying parties (e.g. in the case of a patient it might be the patients key, the practitioners key, the key of the facility, etc.). Just one key or none may suffice, but more may be necessary in some cases. Before the data is stored, the sending entity may also be required to present its credentials at step 54 (e.g. of the same parties as mentioned above for keying).

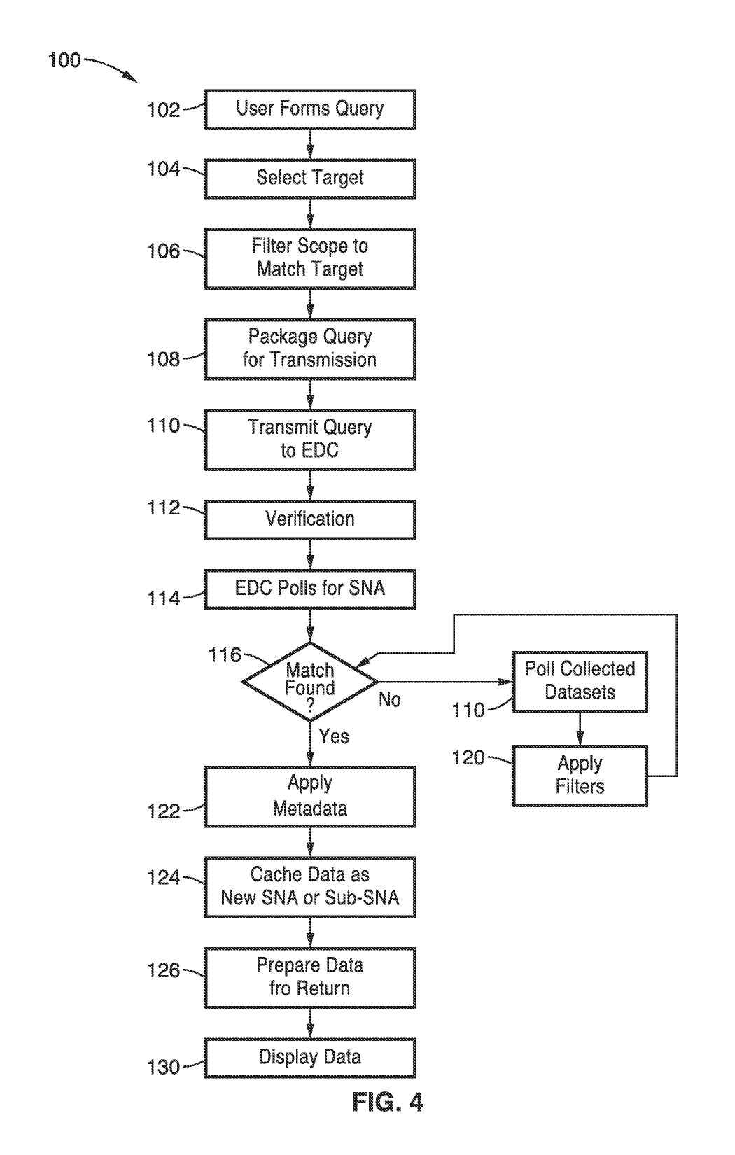

FIG. 4 shows a detailed flow diagram of the data query and return process 100 of the present invention. At step 102, the user forms a query (e.g. with dashboard 450 of FIG. 13), and selects a target at step 104. Requests can be formed explicitly (e.g. tell me the average blood pressure of a 45 year old male) as individual requests or compound requests (e.g. tell me the average blood pressure of a 45 year old male with the following sets of genes). These can be formulated using a command line interface. However, it will be most useful to auto-generate the requests based on a dashboard-like user interface (UI) where the queries are formulated from the questions implied by the structure of the UI (e.g. with dashboard 450 of FIG. 13).

At step 106, the query filters the scope of the lens to match the target (e.g. limits the query to factors that may be relevant to the target, say for questions about heart health it might be age, gender, cholesterol, genetic predisposition, medications taken, etc.). The scope of the data will likely be a default set of data that is automatically generated based on typically expected data points associated with a generic question (like heart health), but any set of arbitrarily close queries can be prepared in advance and cached or completely new queries or variants can be created on the dashboard. The default set of data for any particular data may be based on an expert system that is seeded by a panel of experts but which learns based on the accuracy of its guesses.

At step 108, the dashboard packages the query for transmission. The query may be signed (e.g. with the signature of the patient and then hashed and signed with the signature of the practitioner) and encrypted (e.g. using the data center's public key). At step 110, the data is transmitted to the data processing center (e.g. EDC).

At step 112, the processing center verifies that the patient and practitioner both have valid accounts. This step may further include verification that the data has not been tampered with (e.g. using a hash and signature).

At step 114, the processing center looks for a super-node alias (SNA) that matches the query. The processing center looks for an exact match of the query at step 116. If it finds an SNA that matches the query for this patient, it updates and returns the data.

If an appropriate match is not found, the collected datasets (e.g. what are the cholesterol ranges for men age 45, etc.) are polled at block 110, and filters are applied to the data (like medication regime) at step 120 until the appropriate data sub-set is acquired. The ranges of the filters in step 120 are optimized based on an expert system which can choose ranges based on expected choices and then further based on learning from historical data (e.g. the results vary very little if the age range for a 45 year old man includes people as young as 43 and as old as 47).

In an alternative embodiment (not shown), if step 116 finds an SNA that matches a general query (e.g. factors associated with this disease), it looks for a matched query from this patient (these two steps can be reversed—that is the EDC can start with the patient and then look for the query). Also, if it finds a query that is correct but not current, it updates the data and returns the results. If it finds a general query, but not one from this particular patient, the EDC polls the collected datasets at step 110 (e.g. what are the cholesterol ranges for men age 45, etc.) and keeps applying filters 120 to the data (like medication regime) until the appropriate data sub-set is acquired.

Next, metadata may be applied at step 122, which can be used by applications later in the chain to optimize data parsing and display and to minimize latency and may additionally apply a veracity index based on the quality of the data aggregated.

At step 124, the data is then cached in the EDC (e.g. database 40) as a new SNA or a sub-SNA within a taxonomy of similar classes.

The data is then prepared for return at step 126, e.g. it may be filtered and encrypted with the public key of the dashboard device which made the original query and further encrypted with the public keys of the practitioner and patient.

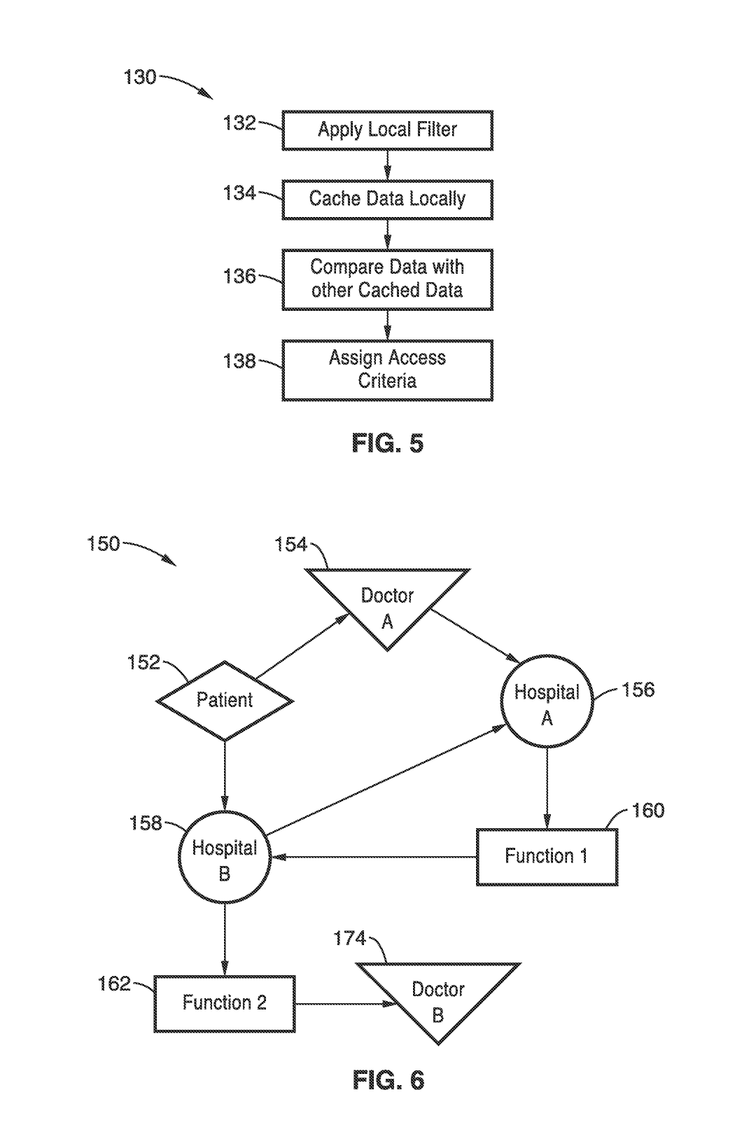

At step 130, the data is displayed to the user in an array of cells as appropriate. FIG. 5 shows a detailed view of display step 130. At step 132 the data is filtered locally to display the relevant portions. The data can also be cached locally at step 134 for comparisons to other data from the same patient in the same session. At step 136, the data is compared with other data cached locally (and more requests from the EDC) to answer multiple queries and perform what-if scenarios. The data may then be cached and accessed by the patient and practitioner at any time.

Should the practitioner want to access the data without the presence of the patient, the patient can give the practitioner or the whole facility (or any granular sub-set) access rights in advance at step 138. These rights can be as long as perpetual but are revocable by the patient or their trustee or other certified surrogate.

Data Protection and Permission Control

Data can be comprised of elements on a home server, a single computer or multiple computers connected on a network or, as may most typically be the case, across a large number of servers, likely redundant, available by use of the Internet or other network.

Because of the extremely large and distributed nature of the data, it is expected that most raw (or semi-raw as results from the preprocessing above) data will be stored in a schemaless (e.g. like NoSQL, Big Table, etc.) fashion. However, many optimizations of this will be required to mitigate the latency and security requirements of the data. Suppose for example, if one is comparing their heart rate history (taking into account factors like my age, blood chemistry) with others in a similar set of groupings, while monitoring the effect of adding diet and exercise regime to the comparison. Not only will millions of data points need to be parsed to come up with the reference, but the data from others will need to be retrieved in an anonymous fashion that cannot be reverse engineered to find out data about any individuals. This requires two important features: 1) enhancements to the newer flat data models to enable not just fast access to a few related bits of data, but to large sets of disparate data that will have to be processed in order to be of use to the end user and 2) enhancements to security access models to allow processes to take place on protected data, while insuring that the data used to make the calculations (and it's sources) remains opaque to all other processes and to all individuals without appropriate permissions. Flexibility of access control—particularly after the fact—is critical because policies and laws are fluid and new restrictions or permissions may appear at any time.

Accordingly, the data storage module 40 will be configured such that data is stored in such a fashion as to facilitate groupings and relationships. Mappings and linkages, though dynamic, will have low-latency and so will be cached in multiple iterations, so as to optimize the multi-data relationship-driven query below.

Individual user data that is gathered locally may be protected using keys associated with the patient and their device. The local device presents its credentials and/or the user's (patient's) credentials. These credentials (and keys) are used not only to protect the data in transit, but are also used to associate the data with the policies to be associated with it when stored at database 40. There may be a default policy when the data is uploaded (e.g. only the practitioner directly associated with the visit or the patient themselves is allowed access to that data). However, (as will be seen below) these policies are preferably dynamic, and can be associated with the data with a high degree of granularity and flexibility.

Once uploaded to database 40, the data may be further protected with an encryption scheme that permits only a particular repository to see into that data. Various layers of permission (e.g. the “license”) are used to augment the granularity of that access. Limitations to access of the uploaded data include but are not limited to: limiting the access to those with the appropriate certificates or keys (e.g. practitioners, hospitals, universities), limiting the time period of that access, limiting the scope of that access to applications with the correct certificates, requirements on levels of anonymity by applications or repositories which store or use the data, etc.

Access to the data requires traversing the nodes of a graph such that the entity wishing access to the data must not only be able to traverse the links of the graph but must abide by the conditions placed within those links.

Referring to the system 150 shown in FIG. 4, patient 152 has a doctor A (154) perform a procedure at hospital A (156). The patient 152 then goes to hospital B (158) to have a follow-up procedure to be performed by Doctor B (174). Doctor B's 174 hospital (hospital B 158) requests the relevant records from hospital A. This permission is given by Doctor B 174 at the patient's request. Doctor A 154 further stipulates in the request that the data may be accessed in the record store of hospital B 158 by anyone who is registered to work on patient 152 within the scope of the ailment.

The scope of the ailment may be determined by algorithms (functions) which operate on the links. Suppose while in hospital B, the patient has need of a different procedure (e.g. he is discovered to have Atrial Fibrillation). The doctors in hospital B would have his permission to work on his A Fib, but might not have visibility into all of patient 152's records. However, because medications that patient 152 may be taking for other ailments could be relevant to his treatment for A Fib, functions (e.g. function 160) embedded in the links would give them that permission. As can be seen in FIG. 6, patient 152 is linked to doctor A, who is linked to doctor B. Since those procedures are performed by that practitioner in that facility, there may not need for any filter or function limiting the access across those links (though it is certainly possible to have filters or function that act on those links if desired). When hospital B requests the records on behalf of doctor B, those records are provided across the links, but are limited by the functions (e.g. function 162) associated with those links so that only doctor B (and his associated staff—perhaps limited in time to the expected time of the access needed) can see those records and can only see the records that may be relevant to the procedure at hand.

Use of Nodes, Links and Filters when Creating and Using Super-node Aliases

Any node can have relationships with other nodes and these relationships can be pre-cached as a super-node.

A Super-node Alias (SNA) is a reference to a set of links, nodes and their functions. For example, the set of all women in their forties who are pregnant and have a specific set of genetic markers can be cached as a super-node alias.

SNAs can be made up of other SNAs. For example: an individual person can be a node (and in some ways a SNA). Suppose all of the data associated with an individual's heart health are an SNA (e.g. heart-rate associated with exercise, cholesterol over time, genetic pre-dispositions, etc.). That same dataset associated with other people in the individual's age bracket is also an SNA. Those people in the individual's range area (e.g. similar cholesterol, genetic profile, etc.) are also an SNA. The individual's doctor can track him/her against his/her “class” and can be notified in the event of anomalous data. The individual can change class based on behavioral factors (exercise, diet, etc.).

The values associated with a super-node alias have a time stamp associated with them. These time-stamp-snapshots can be at predetermined periods (e.g. every hour) or can be generated dynamically (e.g. on demand). Time-stamp-snapshots can be cached (or pre-cached) to limit latency associated with accessing datasets. Time-stamped-snapshots can be used like SNAs and the results of the SNAs can be saved and used as predictive tests going forward.

A detailed, yet parsable, taxonomy is generally needed to find the correct SNA. This will take the form of an SNA schema. The schema will include: the types of data included, their ranges, the sizes of the samples and a globally unique ID (GUID) to represent this particular SNA.

The values of all the links between SNAs can be weighted (the same way that links between nodes above can be weighted). If a link between two different SNAs (or nodes) is not binary, its weight can be determined based on the perceived value of that link. The weighting of a Link can be determined by the probability of effect on the nodes (e.g. 70% likely to have an impact). This probability can be updated over time to reflect new data across the set of all data.

For example: On a scale of 1 to 100, it may be determined that the set of all members with an individual's same cholesterol range was connected to the individual at 100 (by definition, a tautology) but that being a smoker and drinker with type AB positive, the link weighting is set at 7. If you have another SNA of just those people with the same blood type, cholesterol and behavior, the linking would again be 100.

Different parameters can also have different weightings based on the relative importance of those factors. One might say that the cholesterol level has a weighting of 70 (out of 100), the diet has a weighting of 50, the genetic history has a weighting of 35 and the behavioral factors have a collective weighting of 45 (which can be viewed as a super-link, essentially variable based on the collective weightings of its component elements).

Like in other neural nets, the feedback loop should be continuous. The system should keep learning. The collective weighting above is derived from data—particularly data associated with outcomes (e.g., illness, good health, death, etc.). As the outcome data is fed back, the data becomes more and more accurate and the weightings should reflect that.

Collective weighting is also relevant to feedback with regard to the veracity of individual nodes (a patient, a doctor, a disease, a hospital, etc.)

The weighting can be applied by a practitioner based on experience (e.g. there is a 50% chance the patient is remembering the data incorrectly).

Furthermore, as weightings and other data are collected over time, they can be used to develop reputation indices for nodes (e.g. hospital groups, doctors, drugs, etc.). A reputation index may be used to measure the viability of different diagnoses. Suppose a practitioner believes that a patient could be a candidate for hypoglycemia and asks that patient to take a glucose tolerance test. Suppose that 95% of the time this practitioner suggests this particular test, s/he is correct and the patient has a problem with sugar regulation. This practitioner would have a reputation index of 95% with regard to that particular ailment or test. Now suppose another practitioner was more cautious and had many of their patients take the test so that only 30% of their patients showed a problem with sugar regulation. That practitioner would have a 40% reputation index with regard to that particular test.

Similarly, a veracity index may also be employed. The outcome of various treatment recommendations and diagnoses can be compared against the result. For example, if a number of patients try a certain medication, the actual results can be compared with the expected results. In this way you can determine the veracity of the medication for this particular profile of patient (including genetics, lifestyle, age, etc.).

Nodes and Links can be used in a directed graph. For a permission to be given, an application must be able to traverse the path from one node (themselves) to the node(s) needed to execute the function (e.g. the patient or a particular record or a set of data). Moreover functions and filters can be applied to that path. Functions could be as simple as to take an average over a period of time or as complicated as an algorithm that takes into account many functions and data from external sources. For example a function might be to find the average change in cholesterol for males between the ages of 35 and 45 with a systolic blood pressure between 140 and 159 who have been on Angiotensin-converting enzyme (ACE) inhibitors for 90 days who are not overweight and have the genetic variation in the Y chromosome which has shown to have significant effects on male blood pressure in experimental animals. This data could also be filtered for men of Asian descent and compared with men of Eastern European descent.

Each node and link should be encrypted such that only those with the appropriate permissions can traverse the nodes and the links and further such that even within a link, specific functions can be allowed or not. Additionally, the functions will often need to be run in protected space such that only the results can be seen to the querying party and the mechanisms are completely opaque.

Data Nodes can be: patients, diseases, genetic factors, doctors, medications, physical factors or patterns individually or in combination (e.g. heart rate, exercise regimen, heart rate over time, blood levels, etc.), medications and dietary supplements, lifestyle choices, psychological factors or proclivities or any other seeming unrelated factor (like favorite color or fruit).

Among the algorithms that can be applied by a link would be a mechanism to weigh the importance of one set of data to the outcome. For example, one factor (say age range) could be weighed on a scale from 0 to 100 with 100 being absolutely critical to the decision process and 0 being not at all. Some basic weighting might be:
(a) Practitioner's (or any other person's) opinion about the veracity of the data. For example if a patient comes in and says he has stopped drinking but there is liquor on his breath or if a test was done but based on the latest data, the test is now believed to only be accurate 60% of the time.
(b) System derived weightings—beginning as an expert system, the data center would propose values for the importance of various factors. Over time, the system would learn (based on the results of keeping track of its own outcomes) and get more accurate.
(c) Weighting variants can not only be stored but their deltas can be stored. So, for example, if a new set of tests is found that is more reliable than some older tests, the practitioner can determine how much difference the new regime would actually make on the patient in question. This might be useful if, for example, a newer and more accurate test was much more expensive. If, for that particular patient, the deltas were minimal it might not be worth the price but if they were significant, they might.

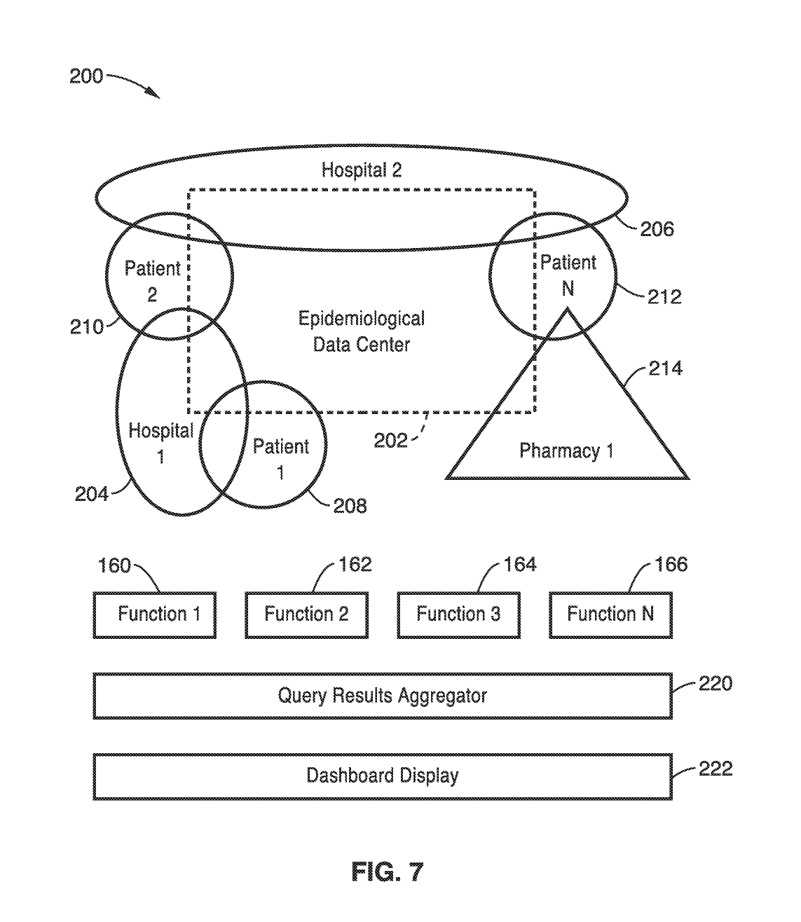

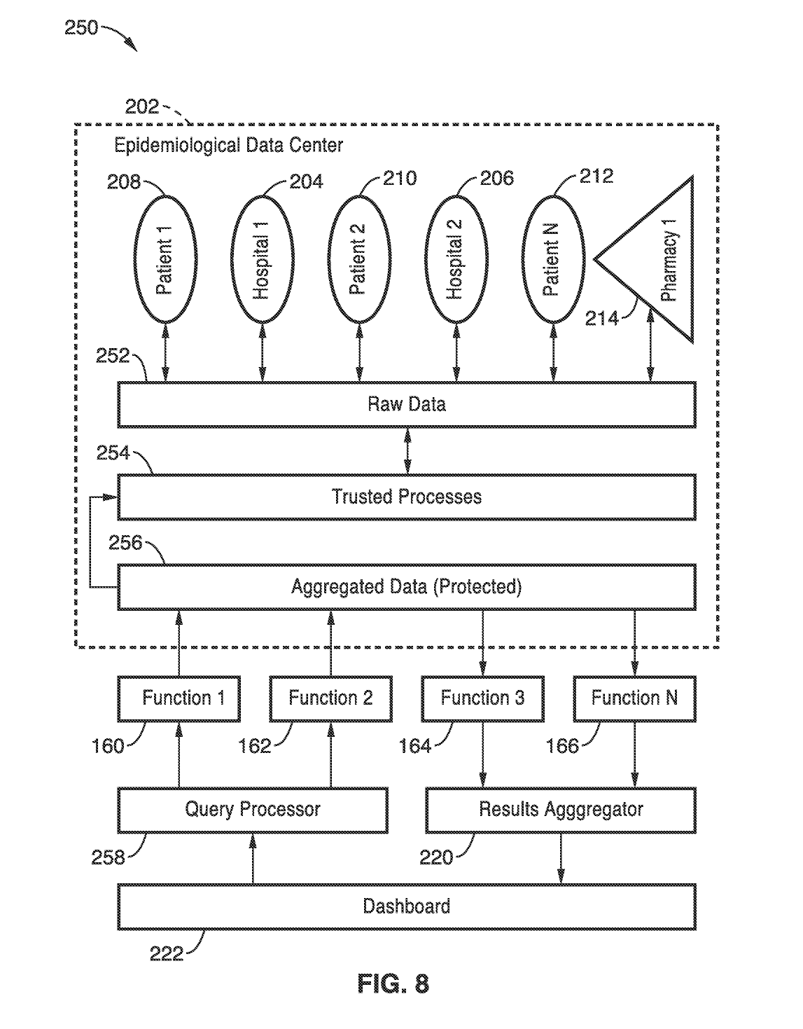

Referring now to FIG. 7 and FIG. 8, nodes, links, filters and functions may be used when creating super node-aliases, which may then be stored as aggregated data in a processing center, or Epidemiological Data Center (EDC) 202.

FIG. 7 is a schematic diagram illustrating the elements used in a system 200 for aggregating data in accordance with the present invention. Patient 1 (208) and patient 2 (210) have used the services of hospital 1 (204), while patient 2 (210) and patient N (212) have used the services of hospital 2 (206). Patient N may also be a customer of pharmacy 1 (214). The system 200 further comprises a query results aggregator 220 that operates under one or more functions 160 (function 1), 162 (function 2), 164 (function 3), and 166 (function N). The dashboard 222 provides the interface for the user's queries into the system.

Suppose a heart patient and his doctor want to determine the optimal drug to reduce the risk of clotting. In this embodiment, epidemiological data of other patients with similar histories and genetic proclivities may be used to determine which medication is best. Suppose, for example, a Neural Net (based on data originally input by doctors but enhanced by observation over time) wants to determine what factors it needs to make this decision effectively. First the net determines how large a sample will likely be necessary to have a response with an accuracy of %99.9. Next it determines the appropriate age range and gender. Then it determines the genetic factors and range of genetic detail needed to be sufficiently relevant.

FIG. 8 is a schematic diagram illustrating system 250 for processing of the query and the creation of aggregated data and their references (super-node aliases). The query processor, 258 (which could be anywhere, including as protected functions within the EDC 202) bundles parameters into a query. This bundling may be done by a number of different functions, 160 (function 1), 162 (function 2), 164 (function 3), and 166 (function N). The queries are sent from the dashboard 222 to the aggregated data store 256 in the EDC, 202. If a response already exists, it may be returned immediately. If an appropriate response does not already exist, a new super node-alias needs to be created.

In a further embodiment, the query is passed to one or more trusted processes 254. These trusted processes 254 query the raw data 252, which may be stored in any number of distributed data centers, or only one data center. This data may have been collected from any number of patients (patient 1 (208), patient 2 (210), patient N (212)) hospitals (hospital 1 (204) and hospital 2 (206)), pharmacies 214, medical practitioners, etc. This raw data is then aggregated into a new SNA which is stored in aggregated data 256. The data stored here may be stored as a copy of the original data or may be stored as only references to it. In one embodiment, a copy of the data is stored and that copy includes a reference to the original data and a time-stamp which can be used to determine the freshness of the data. These references will possibly not refer directly to the raw data but rather to a reference to it created by the trusted processes, which may be used to obfuscate the true source of the original data.

In some embodiments, a linguistic taxonomy (like an XML schema) may be created to map SNAs in a parsable and reference-able format. The schema may be constructed with the target 454 (e.g. the disease (see FIG. 13)) at the top level. Below that will be sub-parts 458 of the taxonomy (e.g. age, gender, critical genetic base pairs, etc.). This schema is then used to describe each particular SNA and can be signed and dated.

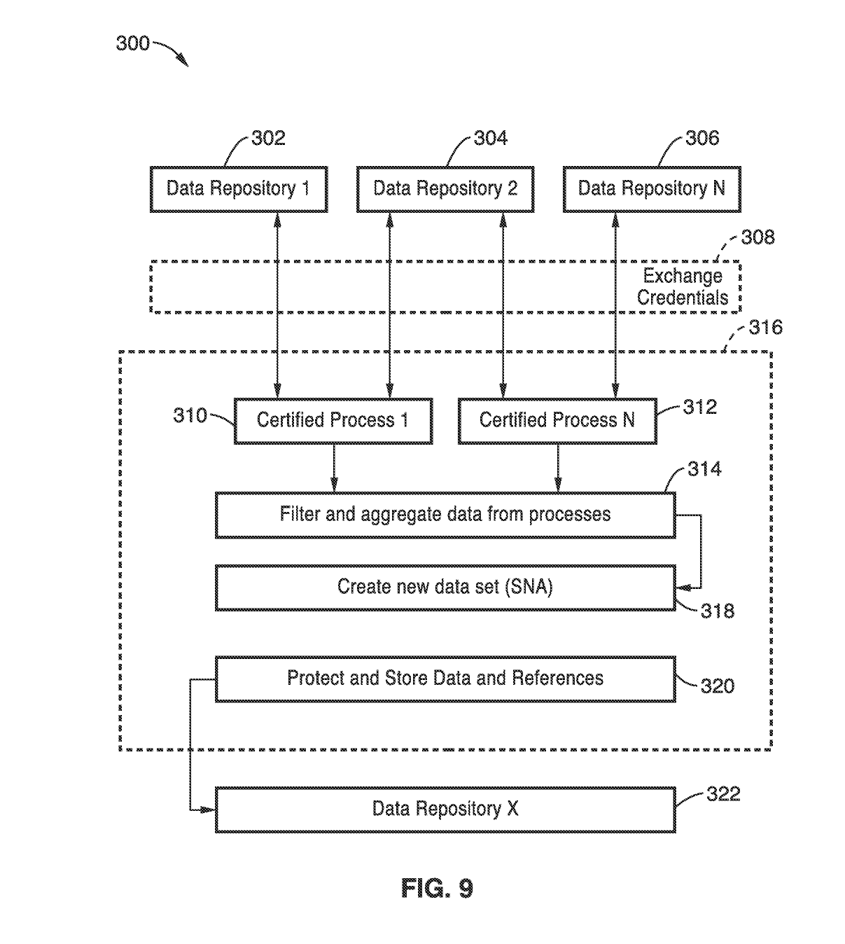

As mentioned above, data used to create SNAs may need to be collected from distributed sources. In such an embodiment, data is collected from multiple distributed sources and acted upon in a secure manner which obscures the sources of the data while still maintaining trust and accountability. As can be seen in the system 300 in FIG. 9, the source may come from multiple data repositories: data repository 1 (302), data repository 2 (304), data repository 3 (306). This data then need to be passed to certified processes 310 and 312 (see Opaque functions below). These are trusted processes. In order for the data to flow from a data repository to a certified process, credentials 308 are exchanged. The credentials 308 are used to verify both the veracity of the data and the metadata but also to certify the roles that these data repositories are certified to play. This credential exchange 308 can be performed using SAML assertions or another similar mechanism. Further, the data may be filtered and aggregated 314, and that data is used to create a new SNA 318. The process 314 which does the filtering and aggregating may itself be a certified process, or the whole set of processes in box 316 may be one big secure process. However, in that event, it may need to present multiple credentials. Once the new SNA is created, it may be tagged with the necessary metadata and the appropriate, possibly obfuscated, references to its original data stored 320. Once it is tagged and protected, it may be stored in a more accessible data repository 322.

In some embodiments, schemas are searched and parsed until it is determined that the exact SNA does not exist. This taxonomy is parsed from the top down (that is from the most general to the most specific) until it reaches the point where it diverges from the results needed for the specific query. Then the SNA that this schema represents is retrieved and the data that is not relevant to the particular query is removed and new data is parsed to properly align the query with a newly created (or evolved) SNA. The schema is then created for this SNA and all the references to it (including signatures, GUIDs, etc.) are created.

In one embodiment, an SNA may comprise a data set that can call signed applications or functions. The application attests (through a SAML assertion or similar) that it will anonymize the data it collects from various sources before dispersing it to an SNA. Signed applications may perform functions such as: selecting the datasets to aggregate based on the query, using algorithms to select the most relevant portions of the data (for example determining based on the data it sees, how to aggregate age filtering for relevance or how to slice the time a drug has been used—does it matter in hours or days or weeks, etc.), applying metadata which can be used by applications later in the chain to optimize data parsing and display and to minimize latency, applying a veracity index based on the quality of the data aggregated, exposing its own reputation index based on the veracity of the data it has historically presented but overall and for this particular type of query, aggregating relevant sets of data from multiple sources and ordering it in more usable structures, and encrypting the data with the public key of the SNA before releasing it back to the SNA.

Using Filters and Functions Across Multiple Nodes

Queries are preferably filtered for permissions. First, it should be determined what data the requestor has permission to view. They may have access to all the raw data or, more likely, access to only some of the data or none at all. As discussed above, a great deal of granularity should be provided in this regard. Access permissions may require anonymity of the sources of the data and limitations regarding the time of use. Also, the requestor may be allowed to view the results of functions that are performed in opaque space (by black boxes). When requesting results from functions performed on anonymous data, the requestor may need metadata regarding the veracity of those transforms (reputation index).

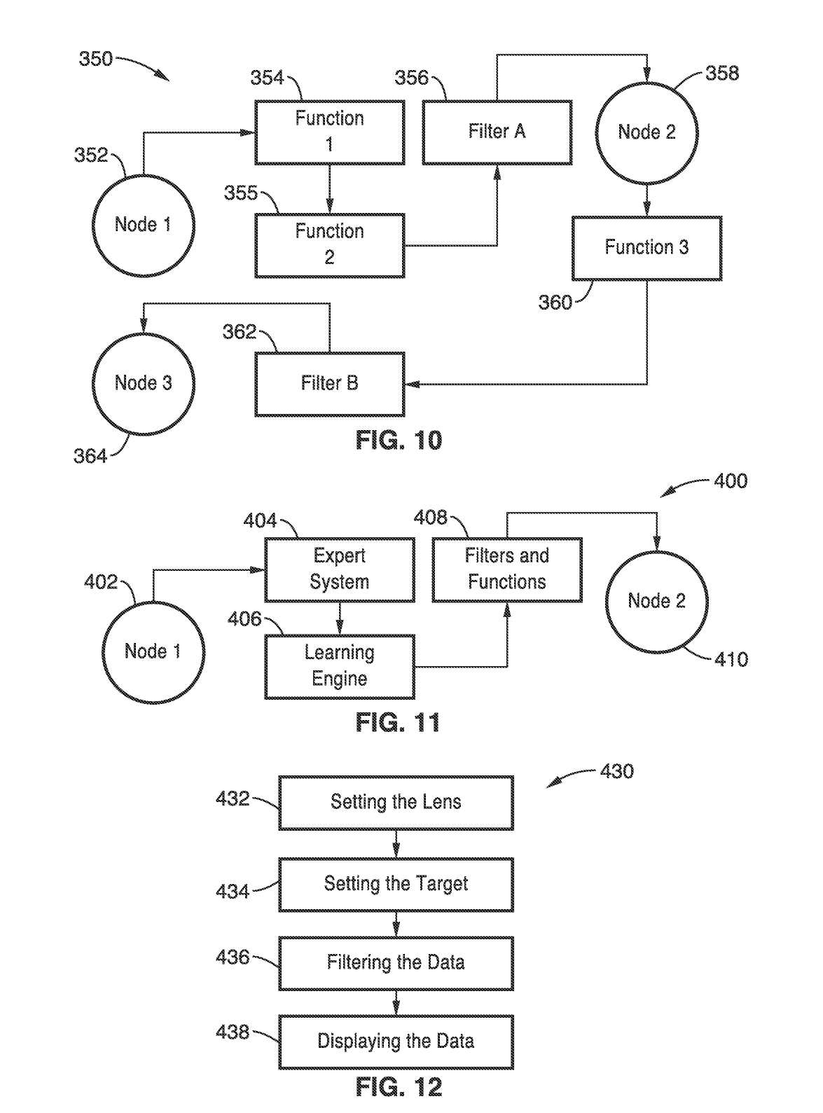

FIG. 10 illustrates a flow diagram of system 350 having various nodes with functions and filters placed between them. In the access to medical data, using one methodology, access to data from one participant by another is limited by the ability to get from one node (e.g. the patient) to another node (e.g. a set of patient data from other patients). Though in some cases a doctor may have access to the results of a relevant trial, he/she would not have access to the rich set of epidemiological data represented by a group of patients with similar traits.

In addition to access permissions from one node to another, there may be additional functions or filters applied when making that access and further, some functions or filters may be required. In system 350, filters and or functions can be placed or required on any link. Suppose node 1 (352, a practitioner examining a patient) is looking for data about a group of patients represented by node 2 (358). If the patient in node 1 is male, filter A (356) might be applied to limit the data from node 2 (358) to only men.

Now suppose we want to know the average cholesterol change after two weeks on a certain drug that was given to the men already filtered in 356. Function 2 (355) could be applied to the data and achieve a result. Now we have a set of data. Now suppose we want to be sure that the set of data selected in function 2, for purposes of anonymity, cannot be traced back to any individuals. Function 1 (354) could be used to confirm that the set of individuals was not traceable back to any individual or hospital (which might have been node 2). This could be done using sample size information, abstracting geographic data or using any of a number of techniques to assure that the sources could not be discovered. Further, the subset of data that was made available by node 2 could have been further constrained by limiting it to the patients seen by a particular group of doctors represented by node 3 (364) and this access could be further controlled by filter B (362) and function 3 (360).

In some embodiments, there may be multiple data domains which may need to be weighted based on their relevance to the desired result. For example, suppose a practitioner wants to determine the correct prescription for a patient with a heart condition. This person's medically relevant data needs to be compared to a control set for optimal recommendation. In this embodiment, first the domains would be selected (e.g. age, gender, genetic profile, cholesterol levels, history of pulse rates, blood pressure, etc.). Then each domain will be weighted based on first scope and then relevance. For example, age.

Referring now to system 400 in FIG. 11, an expert system 404 regarding age and heart health is created. Assuming a panel of doctors has determined that age is relevant, but that a likely range of age to still maintain accuracy is + or −10% (i.e. ±5 years for a 50 year old). This measure of relevance will be adjusted over time by the learning capabilities of the expert system when results are compared with expectations using a learning engine 406. In the case of age, first the function determines the likely age range for comparative subjects (e.g. nodes 402 and 410, note these functions are not limited to age but could be associated with any parameter that could be weighted). Then a similar mechanism is used to determine how important age is to the target disease (say for example the likelihood of atrial fibrillation). Now the filters and functions module (408) choose other records of patients in the target age range and choose a weighting of how important age is to the likelihood of A Fib. This weighting is then factored in with all the other factors (e.g. gender, genetic profile, cholesterol levels, history of pulse rates, blood pressure, etc.) to generate a likelihood of that outcome to this particular individual. As part of this process, changes in any of the factors can be used to determine how they would affect the likelihood of various outcomes.

One factor in weighting the value of different components when creating an SNA is value, based on reputation of the various domains. When using the weighting filters and functions above, reputation is a particular input to a filter of function. In this embodiment, reputation indices can come from a number of different sources. In one embodiment, a reputation index can be generated by the practitioner based on their perceived veracity of the patient data. For example if the patient says s/he has stopped drinking but has liquor on their breath, the doctor might impute a very low Reputation Index. On the other hand, if a patient is meticulous about taking their blood pressure the doctor might surmise that there is a high probability that the patient is taking their medication regularly.

In another embodiment, a reputation index can be surmised from the performance. So for example, when looking at surgical centers, the success rate can be weighed along with the recidivism likelihood along with patient satisfaction to determine a reputation for a particular facility (or Doctor). That can be weighed later against other factors like price and location and scheduling availability.

In a further embodiment, the filtered data that is returned may be checked for anomalies, as particular data blips could cause unpredictable events. For example, an automated data confirmation of the “this is not a reasonable result” type may be used. This automated mechanism can check answers against other factors to flag anomalies or atypical results that could indicate that a result was in error or inaccurate in some way. Examples: Peanut butter is suggested as a healthy alternative to someone who is allergic to peanut butter or mefloquine (an anti-malarial known to have adverse effect on fertility) is prescribed to a woman who is trying to get pregnant and going to Africa when high doses of Doxycycline would be more appropriate.

Some embodiments may include functions for checking for unexpected results. Based on multiple factors of the query, certain results will be “within the norm.” If the result is surprising, it can be rechecked, the user notified and the results can be corrected. Additionally, there may be factors which should preclude certain results. So for example, a person with heart disease should never be given a medication for another ailment that is counter indicated for heart disease. With each patients profile are “key factors” that would normally be counter indicative for certain remedies. For every patient there can be a set of “counter-indicating-factors.” These factors represent a high-level fingerprint of the patient. Any set of basic prognoses like glucose intolerance or heart disease or allergies or psychological instability should be checked when a treatment (including a lifestyle change) is suggested. This can eliminate some of the most inappropriate suggestions.

The generated functions may be opaque. Opaque functions are functions that are performed by software modules. They are considered opaque because both the processes and the source data are opaque to the calling application. In such an embodiment, the recipient of the data does not have the right to view the individual data which is used to create the outcomes to be seen by the user (patient, doctor, etc.). The opaque functions are signed applications that can be trusted to anonymize the data it receives in such a manner as to thwart reverse engineering. It is sometimes possible to determine the source of the data (e.g. an individual patient) from a number of different data points. This must not be allowed (if the person making the query has the right to know individual patient data; that is out of this scope).

In systems and methods of the present invention, many different functions and filters can be performed using opaque Functions. For example one opaque function might take many individual patient records that share factors with the query trying to be answered. These factors could be weighed in all the ways described above to give a trusted result. An opaque function may also have a reputation index as described above.

In some cases, an opaque function may not be able to return a result because anonymity would be compromised. Say you are looking for a rare disease within a narrow set of other parameters. It could turn out that there is a very small set of individuals to compare to—even perhaps only one. In this case, the opaque function would return a list of practitioners corresponding to the patient(s), so that direct inquiries can be made and permission to share the data can be given.

There may be cases where an opaque function may be brought under scrutiny and there must be a means of accountability. In such an embodiment, the inner workings of the functions can be revealed by examining the source functions and possibly the inputs and outputs—possibly with a court order. There must be a secure repository of unprotected source code that can be examined. Additionally, when a function is performed, the source of the data must be recorded and protected in such a fashion that will allow it to be used forensically (e.g. again with a court order).

Creating a Lens and Target in a User Display and Populating with Relevant Data

In preferred embodiments, a dashboard or user display is used as an interface between a person and the data they wish to see. The basic process 430 for creating a lens and target in a user display is shown in FIG. 12. The user first sets the lens at block 432, and then the target at block 434. The data is filtered at block 436 and then the data is displayed at block 438.

FIG. 13 illustrates an exemplary user dashboard 450 for setting a lens and target in accordance with the present invention. The UI dashboard 450 is based on the concept of a lens 452 through which medical data is viewed. The concept is focused on data about patients, diseases, medications, genetic factors, lifestyle factors and the mechanisms employed to optimize the view into that data and how it relates to other factors.

In the example shown in FIG. 13, the lens 452 is a patient and the target 454 is a disease. The basic principle is that the lens 452 is the entity from which the relationship is perceived and the target 454 is the thing that is being looked into.

In particular, the lens 452 is a search, filter, sort and display interface through which to query and cull all other data. Data may be displayed in cells that could represent individual nodes, super-node aliases, or functions applied to nodes or SNAs. The metadata may be present for the dataset and explicitly associated with the dataset. Alternatively, an application can heuristically derive the metadata to associate to the dataset or retrieve the metadata from an alternate source. The lens 452 may also include a filtering mechanism. The total set of all metadata and content elements is limited to only those elements that have relevance to the lens 452 as described below. The lens 452 can further include a display mechanism to display a subset of data in a manner that is easily consumable and understandable to humans. The data in the dataset can have numerous fields and the lens 452 can be set to perform actions on the specific fields.

The lens 452 can be used to find a related element and that element can then become the new lens 452. The dataset is then searched, sorted and filtered on the new lens 452 and the contents are ordered for the new data subset. This creates an environment where the user can effectively surf the information in multiple dimensions and then make each destination a new source—all in an intuitive and associative manner similar to the way the human mind works.

The concept of seeing data arrayed from the point of view of a lens can be very powerful when related to medical data. In the example of FIG. 13, an individual is used as the lens 452. Tin this configuration, the patient or the doctor can see the individual characteristics arrayed as a set of parameters in a dashboard-like display. This display can be ordered based on values (size), based on time, or based on relevance to a characteristic or disease.

As shown in FIG. 4, the target 454 has a “Current” column. This is where the data associated with the lens 452 in its current state is displayed. In the example in FIG. 13, the lens 452 is a patient named John Doe and the target 454 is Heart Disease (it should be noted that the specifics of FIG. 3 are exemplary only, and it is appreciated that numerous other entities may be used in either the lens 452 or the target 454. It is appreciated that the target 454 could be an SNA or a patient, hospital, practitioner, disease etc. The factors which may be considered in relationship to both the lens 452 or the target 454 are arrayed as contributing factors. In the example of FIG. 13, it is factors which may reasonably be considered relevant to John Doe and to Heart Disease. After importing the epidemiological data from all the sources (like an EDC), the data is arrayed in such a manner as to expose the likelihood of various outcomes—e.g. the columns shown under “Likelihood of Outcomes” 456. The Likelihood of Outcomes 456 can be displayed using any of a number of different scales. For example, when using the dashboard 450 to predict the likelihood of an event like a heart attack, it could be on an annual basis or during the next 10 years. When using the dashboard 450 to display the results of a medication, it might show up as a new number in the cholesterol frame.

Suppose, for example, a patient (or practitioner) chooses drinking 1 drink a day and wants to see the probability of medical outcomes (perhaps including death by car accident). The dashboard 450 can order the results by probability. Now, suppose the patient, in the dashboard, changes the number to 2 drinks a day. Next the patient might perhaps want to add filters like, “limit the results to people with the same alcohol related genes (or genetic pre-dispositions). The dashboard 450 could add seemingly unrelated filters like Church attendance or the size of the city where the patient dwells (collaborative filtering often can predict outcomes based on seemingly unrelated factors).

In the dashboard 450 of FIG. 13, the target column 242 further comprises a column labeled “Proposed.” In this area, target numbers can be placed. Then the results are calculated based on what they would have been if those had been the numbers. So, for example, if the likelihood of a heart attack sometime during the next 10 years—taking into account all the other factors in the chart—is, say 15%, how would that number change if the cholesterol number was lowered by 10 points?

Any individual cell within dashboard 450 can be expanded to view or modify details associated with that cell. In one embodiment, the cell could be expanded to show or modify filters or functions (like the reputation index or the dosage of a medication). In another embodiment, if for example the cell represented dietary choices, the expanded cell (or overlay window) could represent a week's worth of menus or a proposed exercise regime or a link to a website (or a link to open a related application like a menu planner). When the menu is entered, it will affect the output of the various prognoses (for example the cholesterol level or the weight or the blood sugar). Note that the same diet might have a different effect on people with different genetic make-ups. So, using the dashboard 450, a patient could see how a change in their diet would likely affect them while the same dietary change might affect their wife in a totally different fashion

One useful capability of the dashboard 450 and its relationship to epidemiological data is its ability to inform decision making. In one embodiment, epidemiological data is brought to the dashboard 450 and displayed in just such a manner. Suppose for example, a practitioner is considering two different drugs for a patient. By mapping the responses to these drugs against others who have taken the same drugs and have the same relevant genomic structure (e.g. using genome-wide association studies or GWAS), the practitioner can determine which drug has the least side effects for my patient.

Similarly to the decision-making embodiment above, in another embodiment, epidemiological data can be used to decide upon procedures. For example, the percentage of risk associated with having an amniocentesis is known (and can be known even more accurately using epidemiological data). The risk of different diseases (those for which the amniocentesis may be used to predict), can also be known based on the genetic makeup of the two (biological) parents. Using an epidemiological dashboard, the risks can be quantified and compared.

Genetics may also be used to define a lens 452 or target 454. One's genetic makeup very much informs who they are from a medical perspective. However, there are some commonalities different persons share with other people. In an epidemiological sense, we need to put one or more aspects of each person genetic makeup into a class that is shared by others with that same or similar make up. There are, for example, indications that a disease may have multiple mechanisms that lead to the same ailment and that these different mechanisms can have different paths to a cure. One factor that can help determine the mechanisms in place is the genetic makeup of the individual. In the present embodiment, we group together different elements of genetic profiles to create a class. This class could be a target or a lens. One class might be a set of factors that make up heart health. Or to be more granular, a single disease could have multiple factors that can cause the illness. For example in diabetes patients, some have difficulty making insulin while others have so called “insulin resistance.” In this embodiment, these two different patients would be in different classes or sub-classes. Classes could be made of any set of tendencies from genetic makeup to lifestyle choices.

Genetic epidemiology may also be used to optimize individualized drug selection. There are multiple choices when selecting drugs to treat patients, and it is known that different patients will react differently to each drug. There are indications that this can be greatly mitigated by mapping against that patient's genetic information. In such an embodiment, epidemiological data is used to compare a patient with a disease to other patients with the same genetic proclivities with regard to that illness and compare the effectiveness of different regimens for those patients with similar relevant genetics. Once the “class” of patient with regard to this ailment is found (taking into account other traits that may be only orthogonally related to the ailment in question), that information can be used to determine the proper course of treatment based on the historic results of similar patients.

In some embodiments, a practitioner may want to know which medication to prescribe for his patient. The practitioner inputs patient data into a query. That data might include the patient's medical history including recent cholesterol readings and blood pressure, genetic profile, family history, dietary and exercise history, physical attributes (weight, height, etc.). The practitioner queries the data for the best prognosis regarding different potential prescriptions that may lower the patient's cholesterol. The practitioner is interested in comparing the relative effectiveness for people like the patient who have used different medications (e.g. Statins, Niacin, Bile-acid resins, Fibric acid derivatives and Cholesterol absorption inhibitors). Based on the epidemiological data returned regarding people with similar medical factors, the practitioner can make a well informed decision.

Epidemiological and biometric data may also be used to inform prophylactic action. There may be cases where actions can be taken in advance to avoid a medical condition (say a colonoscopy at a young age because family history and genetic matching indicate a higher risk of colon cancer). In this embodiment, data is gathered together in the dashboard and used to inform prophylactic action. Based on the risk profile of various possible medical outcomes in life prophylactic action can be taken either as screening procedures, preventative drugs or even pre-emptive operations.

In another embodiment, prophylactic action can be taken in response to a medical condition. A practitioner may notice a potential health issue (say an elevated cholesterol level). The practitioner may use data from the Epidemiological Data Center 202 and compare it to his patient's. The practitioner can give the patient a device that monitors biological functions in real time (perhaps one or more of blood levels, EKG levels, EMG levels, respiration, blood pressure, heart rate, etc.). After a period of time, the practitioner compares the patient's profile with other similar patients and is able to recommend a prognosis. For example, the practitioner may find that similar patients that have changed their lifestyle choices (e.g. exercise regime, diet, etc.) in some particular ways have shown marked improvements. The practitioner can now make that recommendation to the patient.

Epidemiological data may be used to consider the impact of lifestyle changes. It is known that changes in lifestyle can impact the quality of life and mitigate the need for medical procedures and medications. In one embodiment, epidemiological data along with lifestyle data and potentially different lifestyle choices are gathered together in the dashboard 450 and used to inform lifestyle changes. For example, certain exercise regimes or dietary changes could increase the likelihood of a longer life with reduced cholesterol but based on genetic factors, it might be determined that a unique dietary approach (as opposed to the generally applied knowledge) would be better for this users heart health.

The system and method of the present invention may also take into account the optimal sample size/membership for most relevant data mapping. When using epidemiological data to guess the likelihood of relevance, the appropriate sample will need to be taken. For some things, gender may not matter. For other things, an age range of 5 years either side of the patient may be required, while to insure relevance/accuracy for other patients the sample being within 10 years either side of the patient may be sufficient. In this embodiment, the value or veracity of the sample size and component is determined based on using a learning system. This expert system can be seeded with the opinions of experts but should learn over time based on its own epidemiology (similar to the way today's search engines learn from analysis of correct/wrong answers).

Epidemiological data may also be used to determine efficacy and dosage of supplements. The use of herbal remedies and supplements is sometimes questioned because of the lack of reproducible results and clear double-blind studies. Because of the wealth of data in an EDC, this problem could be removed. In this embodiment, users can take supplements and vitamins (potentially of different manufacture) and this can become part of their data record. Once data records including this data proliferate they can be mapped using the epidemiological dashboard to compare the results of different classes of people (including genetic factors) to determine the efficacy of those supplements or herbal remedies to that particular user.

Class may be determined based on a multiplicity of collaboratively filtered data in accordance with the present invention. Collaborative filtering has proven to show relationships where none before were seen (e.g. people who like song a seem to like songs A, B, C and D also like song X even though they are from very different genres and if you like songs A, B, C and D you will likely also like song X even though you would have never anticipated it). In this embodiment, disparate data can easily be compared and patterns uncovered. If, for example, 75% of persons with characteristics A, B, C & D (perhaps never before associated with any particular malady) get a certain disease at a certain age, it can be surmised that if a patient with those same characteristics would be at high risk for that disease and testing or prophylactic action can be taken.

In the case where there is interest in a program of prophylactic diagnostics, a patient's complete work-up can be brought into the system. This work-up includes all the forms of data normally used in epidemiological research including: genetic profile, weight, height, age, address history; sex and marital/relationship history, drug history (pharmaceutical and recreational including alcohol & caffeine); sleep patterns, exercise patterns and dietary data; heart, blood chemistry and brain wave monitoring; etc.

However the exercise also includes disparate data that will be used to predict physiological outcomes based on seemingly unrelated factors like: kinds of film, music and games the patient enjoys; Meyer Briggs score and dozens of other seemingly unrelated personal choices like favorite color, toast darkness, cuts sandwiches on diagonal or not, phone to buzz or ring, hair length, percentage of shoe wearing to sneaker wearing, hobbies, hair color preference in potential mates, etc. After participating for a period of time (i.e. a couple of months), the software can make suggestions about lifestyle changes (i.e. that if the patient took Friday afternoons off of work and caught up with email on Sunday morning that they would have more restful sleep, be more productive at work and have a better relationship with his wife).

The dashboard 450 may also be used to determine and monitor lifestyle changes that may impact the patient's health. In the case where a patient wants to examine their lifestyle in detail, the following process can take place. Using the lens & target dashboard 450, the patient sets themselves as the lens and chooses a set of circumstances (i.e. a disease like heart disease) as the target. All of the patient's medical data is already in the system including all the forms of data normally used in epidemiological research: genetic profile, weight (and weight history), height, age; sex and marital/relationship history, drug history (pharmaceutical and recreational including alcohol & caffeine); sleep patterns, exercise patterns and dietary data; heart, blood chemistry and brain wave monitoring.

The patient can see, considering all the factors accounted for, the expected prognosis with regard to any number of possible outcomes (i.e. the patient's heart life expectancy is age 63). The patient can then look at how different choices might impact the possible outcomes. For example how different drugs might affect the projected outcome or perhaps how lifestyle changes might affect the outcome. From the UI perspective, the dashboard has the ability to model detailed choices like typical menus for dietary adjustments or proposed modifications to exercise regimens.

Insurance companies are in the risk mitigation business. Medical risk varies from patient to patient. Knowing the history of a patient may or may not be allowed (by law) to be used in setting rates, however, lifestyle guarantees or other factors may. An offer may be made to a customer based upon their relationship to the epidemiological data and their health expectations based on that data. For example a user might decide that they are at particularly low risk of colon cancer and might decide not to be covered in that event (or have a very high deductible for that). An insurer might decide that a particular group of insured customers might be eligible for discounts based on their genetic screening. Patients who are at higher risk due to genetic factors could be placed in a pool that was partially subsidized by taxes or the terms of the company's license to practice in a given locale.

An insurance company could change their rates of coverage of different diseases based upon the predictive data as exposed in the epidemiology dashboard. This could be used to give competitive rates to companies for insuring their workforce or to women only or to people who live in Biloxi (this is not that different from today's practice of giving lower rates to younger people).

An insurance company could lower rates based on a patient's promise to make certain lifestyle adjustments (which could be monitored in real time using modern sensor technology).

A health insurance provider can offer a patient further discounts if the patient agrees to real-time monitoring of some of the health related factors (say weight, cholesterol, blood pressure, etc.). If the patient agrees, they will be monitored and if the results are sufficient, the provider can lower their insurance rates. Should the patient drop out of the program, the patient should be able to expunge their health records from the provider.

Embodiments of the present invention may be described with reference to flowchart illustrations of methods and systems according to embodiments of the invention, and/or algorithms, formulae, or other computational depictions, which may also be implemented as computer program products. In this regard, each block or step of a flowchart, and combinations of blocks (and/or steps) in a flowchart, algorithm, formula, or computational depiction can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts, algorithms, formulae, or computational depictions support combinations of means for performing the specified functions, combinations of steps for performing the specified functions, and computer program instructions, such as embodied in computer-readable program code logic means, for performing the specified functions. It will also be understood that each block of the flowchart illustrations, algorithms, formulae, or computational depictions and combinations thereof described herein, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s), algorithm(s), formula (e), or computational depiction(s).

From the discussion above it will be appreciated that the invention can be embodied in various ways, including the following:

1. An epidemiological data management system, comprising: (a) a database configured for storing medical data relating to a plurality of individuals; (b) a user interface coupled to the database; (c) one or more client nodes coupled to the database; (d) the one or more client nodes configured for transmitting data to and receiving data from the database; (e) a processor; and (f) programming executable on the processor configured for: (i) generating a query of the stored medical data from the user interface via a user-controlled interface; (ii) wherein the query comprises a lens and a target; and (iii) wherein the lens comprises an entity within the medical data from which a relationship is perceived and the target comprises one or more factor characteristics to be evaluated; (iv) filtering a scope of the lens to match the target to limit the query to on or more factors that may be relevant to the target; (v) transmitting the query to search the database; (vi) returning data relating to the query; and (vii) displaying said returned data.

2. The system of any preceding embodiment, wherein the query is encrypted prior to transmission.

3. The system of any preceding embodiment wherein each node is encrypted such that only users with the appropriate permissions can traverse between nodes.

4. The system of any preceding embodiment: wherein one or more functions are applied to dictate said permissions; and wherein said functions are operated in protected space such that only the results can be seen to a querying user.

5. The system of any preceding embodiment, wherein the lens comprises a patient and the target comprises a disease.

6. The system of any preceding embodiment: wherein the target or the lens comprises a super-node alias; and wherein the super-node alias comprises a pre-cached relationship between one or more nodes.

7. The system of any preceding embodiment, wherein the super-node alias comprises a linguistic taxonomy that maps the super-node alias in a parsable and reference-able format.

8. The system of any preceding embodiment: wherein said medical data is stored in a plurality of databases; and wherein said medical data is encrypted to hide the source of said data from individual nodes.

9. The system of any preceding embodiment, wherein the user interface comprises a graphical user interface comprising a plurality of fields for the lens, display and one or more fields configured to be populated with data relating to the returned query.

10. The system of any preceding embodiment, wherein the graphical user interface comprises one or more fields for displaying a likelihood of outcomes relating to the query.

11. The system of any preceding embodiment, wherein an individual cell is configured to be expanded to view or modify details associated with that cell.

12. The system of any preceding embodiment, wherein the individual cell is configured to be expanded to show or modify filters or functions associated with said query.

13. A method for epidemiological data management, comprising: providing access to a database configured for storing medical data relating to a plurality of individuals and one or more client nodes configured for transmitting data to and receiving data from the database; generating a query of the stored medical data from the user interface via a user-controlled interface; wherein the query is generated from a user interface; wherein the query comprises a lens and a target; and wherein the lens comprises an entity within the medical data from which a relationship is perceived and the target comprises one or more factor characteristics to be evaluated; filtering a scope of the lens to match the target to limit the query to one or more factors that may be relevant to the target; transmitting the query to search the database; returning data relating to the query; and displaying said returned data.

14. The method of any preceding embodiment, wherein the query is encrypted prior to transmission.

15. The method of any preceding embodiment, further comprising encrypting each node such that only users with the appropriate permissions can traverse between nodes.

16. The method of any preceding embodiment: wherein one or more functions are applied to dictate said permissions; and wherein said functions are operated in protected space such that only the results can be seen to a querying user.

17. The method of any preceding embodiment, wherein the lens comprises a patient and the target comprises a disease.

18. The method of any preceding embodiment: wherein the target or the lens comprises a super-node alias; and wherein the super-node alias comprises a pre-cached relationship between one or more nodes.

19. The method of any preceding embodiment, wherein the super-node alias comprises a linguistic taxonomy that maps the super-node alias in a parsable and reference-able format.

20. The method of any preceding embodiment: wherein said medical data is stored in a plurality of databases; and wherein said medical data is encrypted to hide the source of said data from individual nodes.

21. The method of any preceding embodiment, wherein the user interface comprises a graphical user interface comprising a plurality of fields for the lens, display and one or more fields configured to be populated with data relating to the returned query.

22. The method of any preceding embodiment, wherein the graphical user interface comprises one or more fields for displaying a likelihood of outcomes relating to the query.

23. The method of any preceding embodiment, wherein an individual cell is configured to be expanded to view or modify details associated with that cell.

24. The method of any preceding embodiment, wherein the individual cell is configured to be expanded to show or modify filters or functions associated with said query.

25. An epidemiological data management system, comprising: (a) a database configured for storing medical data relating to a plurality of individuals; (b) said medical data relating to one or more client nodes configured for transmitting data to and receiving data from the database; (c) a user interface coupled to the database; (d) a processor; and (e) programming executable on the processor configured for: (i) generating a query of the stored medical data from the user interface via a user-controlled interface; (ii) wherein the query comprises a lens and a target; and (iii) wherein the lens comprises an entity within the medical data from which a relationship is perceived and the target comprises one or more factor characteristics to be evaluated; (iv) filtering a scope of the lens to match the target to limit the query to on or more factors that may be relevant to the target; (v) transmitting the query to search the database; (vi) returning data relating to the query; and (vii) displaying said returned data.

26. The system of any preceding embodiment, wherein the query is encrypted prior to transmission.

27. The system of any preceding embodiment, wherein each node is encrypted such that only users with the appropriate permissions can traverse between nodes.

28. The system of any preceding embodiment: wherein one or more functions are applied to dictate said permissions; and wherein said functions are operated in protected space such that only the results can be seen to a querying user.

29. The system of any preceding embodiment, wherein the lens comprises a patient and the target comprises a disease.

30. The system of any preceding embodiment: wherein the target or the lens comprises a super-node alias; and wherein the super-node alias comprises a pre-cached relationship between one or more nodes.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An epidemiological data management system, comprising:
(a) a database configured for storing medical data relating to a plurality of individuals;
(b) a user interface coupled to the database;
(c) one or more client nodes coupled to the database;
(d) the one or more client nodes configured for transmitting data to and receiving data from the database;
(e) a processor; and
(f) programming executable on the processor and configured for:
(i) generating a query of the stored medical data from the user interface via a user-controlled interface;
(ii) wherein the query comprises a lens and a target; and
(iii) wherein the lens comprises an entity within the medical data from which a relationship is perceived and the target comprises one or more factor characteristics to be evaluated;
(iv) filtering a scope of the lens to match the target to limit the query to on or more factors that may be relevant to the target;
(v) transmitting the query to search the database;
(vi) returning data relating to the query; and
(vii) displaying said returned data.

2. A system as recited in claim 1, wherein the query is encrypted prior to transmission.

3. A system as recited in claim 1, wherein each node is encrypted such that only users with the appropriate permissions can traverse between nodes.

4. A system as recited in claim 3:
wherein one or more functions are applied to dictate said permissions; and
wherein said functions are operated in protected space such that only the results can be seen to a querying user.

5. A system as recited in claim 1, wherein the lens comprises a patient and the target comprises a disease.

6. A system as recited in claim 1:
wherein the target or the lens comprises a super-node alias; and
wherein the super-node alias comprises a pre-cached relationship between one or more nodes.

7. A system as recited in claim 6, wherein the super-node alias comprises a linguistic taxonomy that maps the super-node alias in a parsable and reference-able format.

8. A system as recited in claim 1:
wherein said medical data is stored in a plurality of databases; and
wherein said medical data is encrypted to hide the source of said data from individual nodes.

9. A system as recited in claim 1, wherein the user interface comprises a graphical user interface comprising a plurality of fields for the lens, display and one or more fields configured to be populated with data relating to the returned query.

10. A system as recited in claim 9, wherein the graphical user interface comprises one or more fields for displaying a likelihood of outcomes relating to the query.

11. A system as recited in claim 9, wherein an individual cell is configured to be expanded to view or modify details associated with that cell.

12. A system as recited in claim 11, wherein the individual cell is configured to be expanded to show or modify filters or functions associated with said query.

13. A method for epidemiological data management, comprising:
providing access to a database configured for storing medical data relating to a plurality of individuals and one or more client nodes configured for transmitting data to and receiving data from the database;
generating a query of the stored medical data from the user interface via a user-controlled interface;
wherein the query is generated from a user interface;
wherein the query comprises a lens and a target; and
wherein the lens comprises an entity within the medical data from which a relationship is perceived and the target comprises one or more factor characteristics to be evaluated;
filtering a scope of the lens to match the target to limit the query to one or more factors that may be relevant to the target;
transmitting the query to search the database;
returning data relating to the query; and
displaying said returned data.

14. A method as recited in claim 13, wherein the query is encrypted prior to transmission.

15. A method as recited in claim 13, further comprising encrypting each node such that only users with the appropriate permissions can traverse between nodes.

16. A method as recited in claim 15:
wherein one or more functions are applied to dictate said permissions; and
wherein said functions are operated in protected space such that only the results can be seen to a querying user.

17. A method as recited in claim 13, wherein the lens comprises a patient and the target comprises a disease.

18. A method as recited in claim 13:
wherein the target or the lens comprises a super-node alias; and
wherein the super-node alias comprises a pre-cached relationship between one or more nodes.

19. A method as recited in claim 18, wherein the super-node alias comprises a linguistic taxonomy that maps the super-node alias in a parsable and reference-able format.

20. A method as recited in claim 13:
wherein said medical data is stored in a plurality of databases; and
wherein said medical data is encrypted to hide the source of said data from individual nodes.

21. A method as recited in claim 13, wherein the user interface comprises a graphical user interface comprising a plurality of fields for the lens, display and one or more fields configured to be populated with data relating to the returned query.

22. A method as recited in claim 21, wherein the graphical user interface comprises one or more fields for displaying a likelihood of outcomes relating to the query.

23. A method as recited in claim 21, wherein an individual cell is configured to be expanded to view or modify details associated with that cell.

24. A method as recited in claim 23, wherein the individual cell is configured to be expanded to show or modify filters or functions associated with said query.

25. An epidemiological data management system, comprising:
(a) a database configured for storing medical data relating to a plurality of individuals;
(b) said medical data relating to one or more client nodes configured for transmitting data to and receiving data from the database;
(c) a user interface coupled to the database;
(d) a processor; and
(e) programming executable on the processor and configured for:
(i) generating a query of the stored medical data from the user interface via a user-controlled interface;
(ii) wherein the query comprises a lens and a target; and
(iii) wherein the lens comprises an entity within the medical data from which a relationship is perceived and the target comprises one or more factor characteristics to be evaluated;
(iv) filtering a scope of the lens to match the target to limit the query to on or more factors that may be relevant to the target;
(v) transmitting the query to search the database;
(vi) returning data relating to the query; and
(vii) displaying said returned data.

26. A system as recited in claim 25, wherein the query is encrypted prior to transmission.

27. A system as recited in claim 25, wherein each node is encrypted such that only users with the appropriate permissions can traverse between nodes.

28. A system as recited in claim 27:
wherein one or more functions are applied to dictate said permissions; and
wherein said functions are operated in protected space such that only the results can be seen to a querying user.

29. A system as recited in claim 25, wherein the lens comprises a patient and the target comprises a disease.

30. A system as recited in claim 25:
wherein the target or the lens comprises a super-node alias; and
wherein the super-node alias comprises a pre-cached relationship between one or more nodes.
